(19) United States
(12) Patent Application Publication
(10) Pub. No.: US 2010/0088294 A1
(43) Pub. Date: Apr. 8, 2010

(54) INFORMATION PROCESSING METHOD AND SYSTEM OF THE SAME

(76) Inventors: Hong-Yung Wang, Sindian City (TW); Ming-Hua Chen, Sindian City (TW)

Correspondence Address: FITCH EVEN TABIN & FLANNERY, 120 SOUTH LASALLE STREET, SUITE 1600, CHICAGO, IL, 60603-3406, US

(21) Appl. No.: 12/245,550

(22) Filed: Oct. 3, 2008

(51) Int. Cl. G06F 17/30; G01S 1/00

(52) U.S. Cl. 707/705; 342/357.06; 707/E17.044

(57) ABSTRACT

An information processing method is implemented by an information processing system. The system has a media file generator, a GPS recorder and a data processing system. The data processing system obtains media files and creation times from the media file generator and geographical items from the GPS recorder. Since each geographical item includes a recording time, a geographical coordinate, speed and heading, the data processing system simulates a continuous track in time sequence. The data processing system matches the creation time of each media file to the corresponding time on a time base of the continuous track and then determines the corresponding geographical coordinate of each media file to the geographical coordinate of the continuous track corresponding to the matched time.

### BACKGROUND OF THE INVENTION

1. Field of the Invention

The present invention relates to an information processing method and system of the same, and more particularly to an information processing method and system of the same that processes media files to match the proper geographical coordinate.

2. Description of Related Art

As the Globe Positioning System (GPS) device has gradually popularized, the GPS device is applied to different portable products to provide geographical items for the portable product. In media technical filed, someone proposed a new method of reviewing media files on an image of an electric map. That is, when the computer stores the media files and the geographical coordinates thereof, the computer executes the new reviewing method to mark positions of the media file on the image of the electric map according to geographical coordinates. Therefore, the user easily remembers more content recorded in the media files, when the media files are displaying on the map.

In order to implement the above reviewing method, the geographical coordinate of each media file has to be obtained. Therefore, an improved media device is proposed and has an embedded GPS module. For example, when the user presses button of a digital camera to shoot an image, one picture is generated. At the time, the embedded GPS module outputs one geographical item including the present geographical coordinate. Thus, the media device generates the picture and the geographical coordinate.

If the user does not buy the new digital camera having GPS module mentioned above, the user also has the alternative of bringing the individual GPS device when the user uses the digital camera. Since the GPS device generates geographical items periodically for a recording period and outputs a history file including the geographical items. Each geographical item at least includes a geographical coordinate and a recording time. When a computer downloads the history file from the GPS device and the media files from the digital camera, the computer determines one geographical item for each media file by comparing the creation time of each media file and a corresponding recording time of the geographical item. If the corresponding recording time matches to the creation time of the media file, the computer determines that the geographical coordinate corresponding the recording time is the location where the media file is generated.

Since each geographical item at least has the geographical coordinate and the recording time, a diagram of the history file is shown as FIG. 5. The geographical coordinate has represented to longitude and latitude and the recording time is Coordinated Universal Time (UTC). The recording times of each geographical items in the history file have a fixed time interval in normal receiving condition. However, some geographical items in the history file will be missed since the GPS device is sheltered by building or the like, or receives weak satellite signals. With reference FIG. 5, an example of the history file, four recording times (t3 to t6) do not have corresponding geographical coordinates. Further, since the recording period of the history file in FIG. 5 starts from t0 and ends at t9, six times (t0 to t2, t7 to t9) have the corresponding geographical coordinates (A, B, C, X, Y and Z).

When one or more media files are generated during t3 to t6, the computer does not determine one proper geographical coordinate to the one or more media files. Therefore, the one or more position of the one or more media files are not marked on the image of the electric map. In addition, since the geographical items are recorded periodically, other media file is not determined to the corresponding geographical coordinates by the computer, if the creation time of one media file is between two recording times having geographical coordinates, for example between t0 and t1.

The EP patent application of publication number 1087605A2 or the U.S. patent application of publication No. 6,871,004 discloses an information processing method to solve the drawback as mentioned above. With further reference to FIG. 6, an example of determining the geographical coordinate of one media file (F1) by the method is shown. When the creation time (10:32:40) of one media file (F1) is between two recording times (10:32:30) (10:33:00) having geographical coordinates (N: 42° 32′ 35″; E: 135° 12′ 10″) (N: 42° 32′ 35″; E: 135° 00′ 40″). In the method, a time proportion of T_{A-F1} to T_{F1-B} is firstly calculated to 1:2. At the time, a straight-line track between the two geographical coordinates (A, B) is calculated and then divided into three uniform parts according to an amount of the time proportion. Therefore, the simulated geographical coordinate (N: 42° 32′ 35″; E: 135° 08′ 20″) of the media file (F1) is determined at the point adjacent between the first and second parts of the straight-line tract according to the time proportion of 1:2.

Based on the method of the above patent application, the simulated geographical coordinate is determined, but the straight-line tract is not an actual track of the user's action or a general road. Therefore, the media files are roughly marked on the image of the electronic map according to the simulated geographical coordinates.

To overcome the shortcomings, the present invention provides a new information processing method and system of the same to mitigate or obviate the aforementioned problems.

### SUMMARY OF THE INVENTION

The main objective of the present invention is to provide an information processing method and system of the same that processes media files to match the proper geographical item.

The information processing method in accordance with the present invention has steps of (a) obtaining a history file for a recording period including multiple geographical items; (b) simulating a segment of continuous track between each two adjacent geographical items; (c) connecting all segments to complete the continuous track in time sequence; (d) obtaining multiple media files and creation times thereof, wherein the creation times of the media files are in the recording period of the history file; (e) adjusting the creation time of one of the media files to match on an actual time base of the history file; (f) calculating a time difference between the original creation time and the adjusted time; (g) adjusting the creation times of the reset of the media files to shift to the time difference; and (h) determining the corresponding geographical coordinate of each media file to the geographical coordinate of the continuous track corresponding to adjusted time of the media file.

The information processing system in accordance with the present invention has a media file generator, a GPS recorder and a data processing system. The media file generator generates media files each of which has a creation time. The GPS recorder generates a history file having multiple geographical items each of which has a recording time, a geographical coordinate, speed and heading. The data processing system is connected to the media file generator and the GPS recorder to obtain the multiple media file. The data processing system executes the information processing method in accordance with the present invention.

Other objectives, advantages and novel features of the invention will become more apparent from the following detailed description when taken in conjunction with the accompanying drawings.

### BRIEF DESCRIPTION OF THE DRAWINGS

FIG. 1 is a flow chart of an information processing method in accordance with the present invention;

FIGS. 2A to 2C shows a continuous track is generated by the information processing method in accordance with the present invention;

FIG. 3 is a diagram of the continuous track on which multiple geographical coordinates are marked;

FIG. 4 is a functional block diagram of an information processing method in accordance with the present invention;

FIG. 5 is a recording time versus position diagram for a history file generated from a GPS device; and

FIG. 6 is a FIG. 30 of EP patent application of patent number 1087605A2.

### DETAILED DESCRIPTION OF THE INVENTION

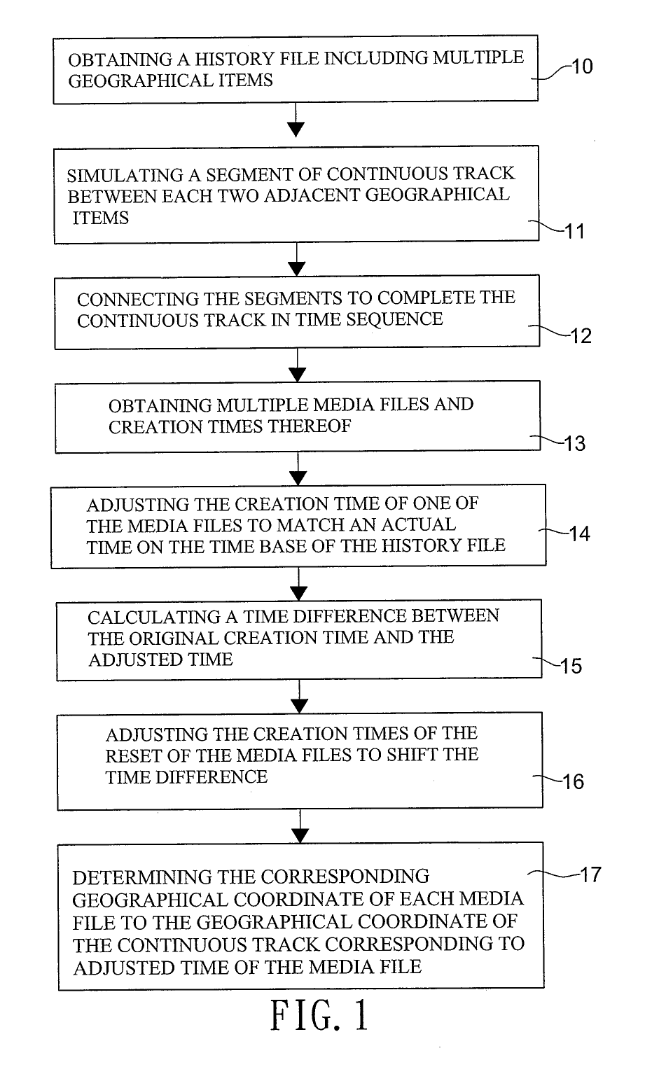

With reference to FIG. 1, a flow chart of a method in accordance with the present invention has following steps.

In step (a), a history file for a recording period including multiple geographical items is obtained (10). Each geographical item at least has a recording time, a geographical coordinate, speed and heading etc. The geographical coordinate may be a longitude and latitude, or X-axis and Y-axis. The recording time is a Coordinated Universal Time (UTC).

In step (b), a segment of a continuous track between each the two adjacent geographical items is simulated according to two geographical coordinates, speeds and headings (11). The continuous track is not straight line.

In step (c), all segments are connected to complete the continuous track in time sequence (12).

In step (d), multiple media files and creation times thereof are obtained (13), wherein the creation times of the media files are in a recording period of the history file.

In step (e), the creation time of one of the media files is adjusted to match an actual time on a time base of the history file (14).

In step (f), a time difference between the original creation time and the adjusted time is calculated (15).

In step (g), the creation times of the rest of the media files are adjusted to shift to the time difference (16).

In step (h), the corresponding geographical coordinate of each media file is determined to the geographical coordinate of the continuous track corresponding to adjusted time of the media file (17).

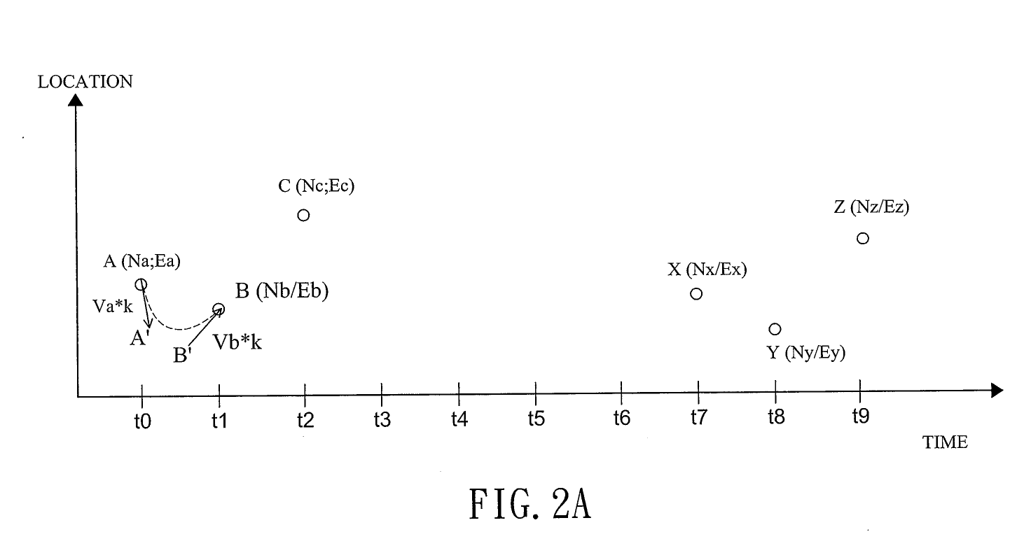

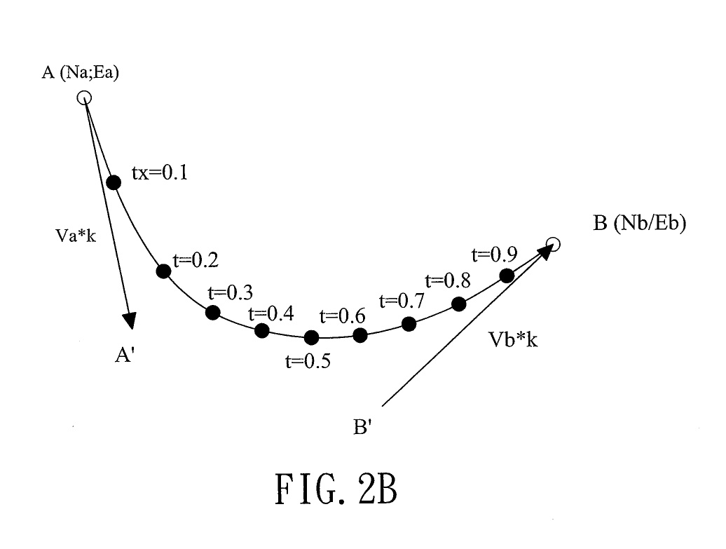

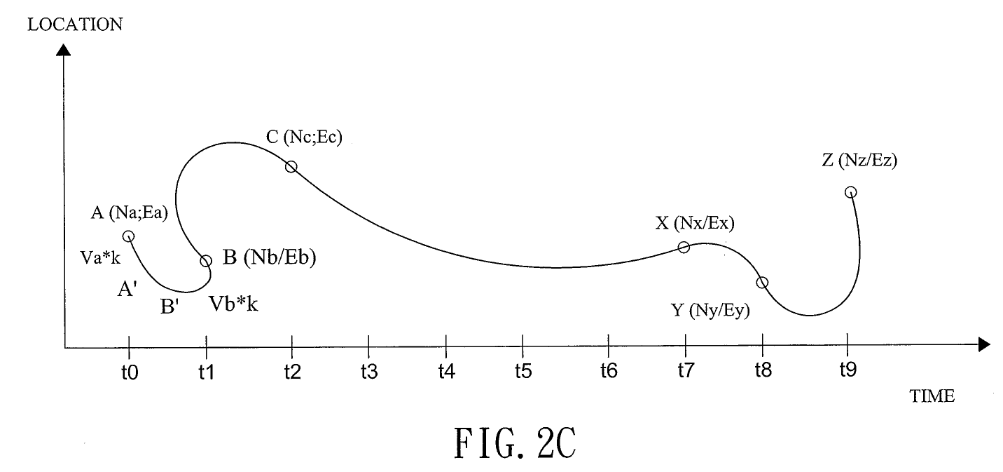

In a preferred embodiment, With reference to FIGS. 2A and 2B, The two adjacent geographical items (A, B) of the history file respectively have the recording times, the geographical coordinates, the speeds and the headings. Two control points (A′, B′) of the two adjacent geographical items (A, B) are calculated by the recording times, the geographical coordinates, the speeds (Va, Vb) and the headings. That is, the speeds (Va, Vb) are respectively multiplied by a parameter K to have two products. Then the two products are further converted to two vectors according to the two headings. The two vectors are transformed into the control points (A′, B′) of the two adjacent geographical coordinates. Further, the parameter K may be automatically designated by a program or manually set.

In a preferred embodiment, a cubic Bézier curve equation is used to calculate the segment of the each two adjacent geographical coordinates. The cubic Bézier curve equation is B(t)=A(1−t)³+3A′t(1−t)²+3Bt²(1−t)+B′t³;t ε[0,1]. Since two geographical items and two control points (A, A′, B, B′) are parameters of the cubic Bézier curve equation, a crooked line is determined and the continuous and crooked line is the segment of the continuous track between the two adjacent geographic items (A, B). The cubic Bézier curve equation is a preferred embodiment of simulating the segment, but other Bézier curve equation or the like should be proper equation to simulate the segment.

Therefore, other segments of the continuous track of the rest of the each two adjacent geographic items (B to C) (C to X) (X to Y) (Y to Z) are determined by executing the above steps. With further reference to FIG. 2C, when the all segment of the continuous tracks are connected, the continuous track is complete during the recording period of the history file.

The cubic Bézier curve equation has a time parameter (t) that presents a proportion of an arbitrary time (tx) and the two recording times (t0, t1) of the two the adjacent geographical items (A, B). For example, at to the recording time (t0), the time parameter is assumed to 0 (t=0), and as to the recording time (t1), the time parameter is assumed to 1 (t=1). Therefore, when the arbitrary time point (tx) is known and between t0 to t1, the proportion (Pt) of the tx, t0 and t1 is calculated by an equation: t=(tx−t0)/(t1−t0). After the proportion is determined, a geographical coordinate corresponding to the arbitrary time (tx) is found by calculating the B(t=Pt).

For example, with further reference to FIG. 2B, if the domain time (tx) between the two creation times (t0, t1) of the two adjacent geographical items (A, B) is 0.1, the proportion (Pt) is determined to 0.1. That is, the segment of the continuous track is divided into ten parts (0.1 to 0.9) and the geographical coordinate of the first part corresponding to the arbitrary time (tx=0.1) is determined. If the creation time of one media file matches the arbitrary time (tx), the geographical coordinate of the continuous track corresponding to the arbitrary time (tx) on the time base of the continuous track can be determined. Therefore, if the creation time of the media file is between the two recording times (t0, t1) of the two adjacent geographical items (A, B) of the history file, the geographical coordinate of the media file can be determined.

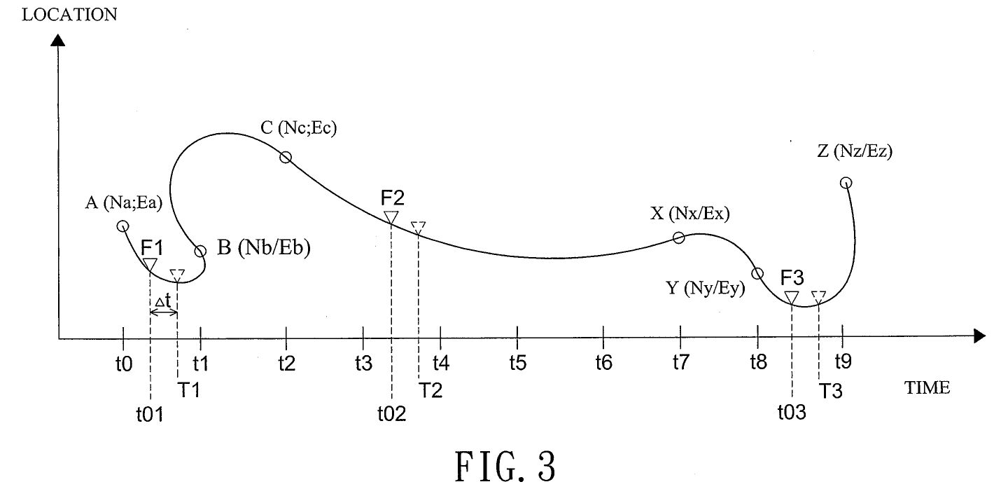

With further reference to FIG. 3, for example, three media files (F1, F2, F3) are generated during the recording period of the history file. The original creation times of the media files are T1, T2 and T3 on the UTC time base of the continuous track. Since the creation time of the media file may not be UTC time, the creation time of one of the media files (F1, F2, F3) need to be adjusted to an actual time on the UTC time base of the continuous track. With the method introduced below, the user could adjust one of the media file's actual time, for example, the media file F1. After the creation time of the media file (F1) is adjusted, the adjusted time is a new creation time (t01) of the media file (F1). Then, the time difference Δt is calculated between the original and new creation times (T1, t01). The time difference Δt could be a negative number or positive number. The two original creation times (T2, T3) of other two media files (F2, F3) are adjusted to shift one time difference Δt on the UTC time base of the continuous track. Therefore, the geographical coordinates of the three media files (F1, F2, F3) are respectively obtained by calculating the cubic Bézier curve equation with the new creation times.

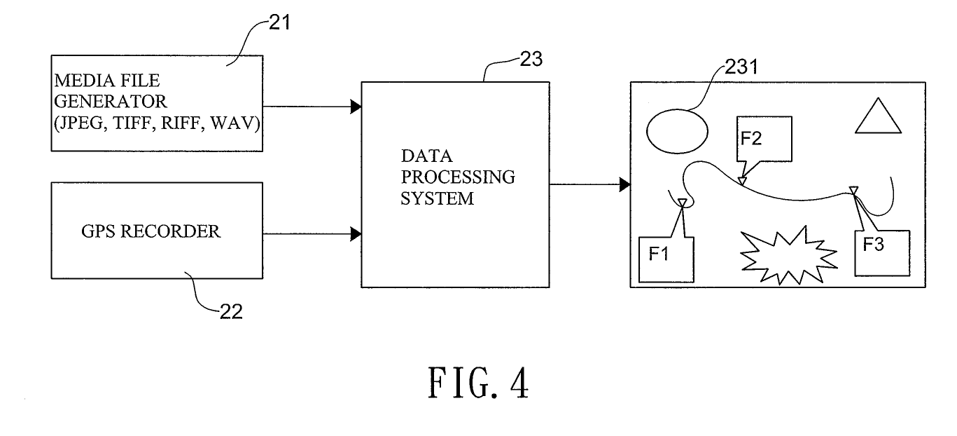

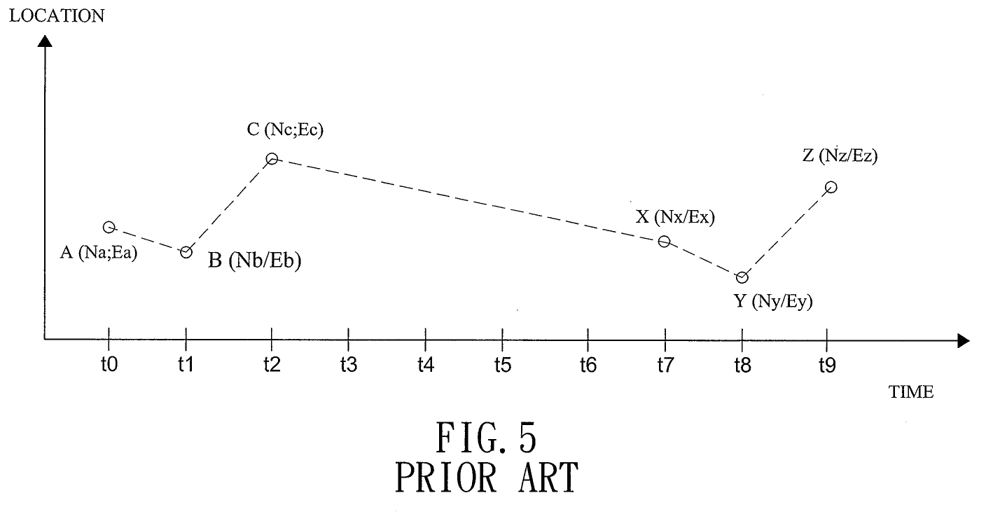

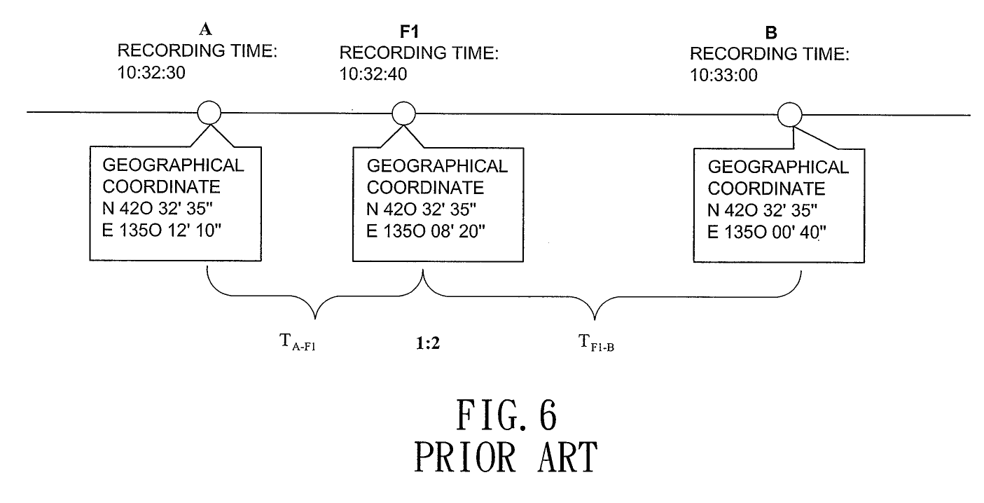

With reference to FIG. 4, a functional block diagram of an information processing system in accordance with the present invention is shown. The information processing system has a media file generator (21), a GPS recorder (22) and a data processing system (23). The media file generator (21) may be a digital camera, digital audio recorder or the like and generates media files, such as pictures, movies, audio signals etc. Each media file includes the creation time which is countered by an embedded clock or counter of the media generator (21). The clock generates local time, so the creation time is not a UTC time in general. The creation time is recorded within the Exchangeable Image File Format (EXIF) of the corresponding media file, if the media file generator (21) supports the EXIF. If the media file generator (21) does not support the EXIF, the local time, when each media file is generated, is treated as its creation time.

The GPS recorder (22) generates a history file for a recording period and has a GPS receiver and a memory unit. When the GPS receiver receives the satellite signals periodically, multiple geographical positions and times are stored in the memory unit during the recording period. According to the GPS satellite signal, the GPS receiver continuously calculates current time, geographical coordinate, speed and heading etc. Therefore, during the recording period of the history file has multiple geographical items. The geographical coordinate may be a longitude and latitude, or X-axis and Y-axis. The recording time is a Coordinated Universal Time (UTC).

The media generator (21) and the GPS recorder (22) are connected to the data processing system (23) when downloading the media files and GPS history files. The data processing system (23) may be a computer, a web server or a CPU embedded in the media file generator (21) or in the GPS recorder (22) having external program codes. In addition, the GPS recorder (22) could be embedded inside the media file generator (21). The data processing system (23) stores and executes the information processing method in accordance with the present invention. The data processing system displays the continuous track and the media files marked on the continuous track on an image of an electric map.

The data processing system (23) downloads the media files from the media file generator (21) and the history file from the GPS recorder (22). With further reference to FIG. 1, when the data processing system (23) executes the information processing method, the media files and the history files are obtained. In order to easily adjust the creation time of one media file to match an actual UTC time on the time base of the continuous track, the data processing system (23) displays the continuous track and the media file marked on the continuous track on an image of an electronic map (231). Therefore, the user easily checks whether the location of the media file marked on the image of the electric map (231) is correct. If the user adjusts the location of the media file, the data processing system (23) calculates the time difference Δt and applies Δt to the rest of the media files as mentioned above.

Furthermore, the time difference Δt is kept. If the data processing system obtains a new set of media files from the same media file generator next time, the data processing system automatically adjusts creation times of a new set of media files downloaded from the same media file generator to shift the time difference on the UTC time base of the continuous track. Since the time difference between the media file generator and UTC was adjusted by the user and kept in the system, the time adjustment procedure is not necessary again. However, if the locations marked on the electronic map is not the actual locations where the media files are generated, the user may repeatedly adjusts the creation time of one media file and executes the steps (c) to (e).

After the data processing system executes the step of determining the corresponding geographical coordinate of each media file, the data processing system displays the continuous track and the media files marked on the continuous track on the image of the electric map. The user reviews the media files and the locations of the map where the media files are generated.

Based on the foregoing description, the present invention has advantages as follow.

1. Even different media files generated in different time zones, the information processing method respectively processes each media file to match the corresponding geographical coordinate efficiently.

2. Since each geographical item includes speed and the heading, the estimated continuous track more approaches to the actual road or location in most cases.

3. The continuous track is not a straight-line track, some missed geographical records as result of weak satellite signals are re-obtained.

4. The user only uses individual GPS recorder, and individual media file recorder. Then the geographical locations of the media files be created could be obtained.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. An information processing method comprising steps of:
obtaining a history file for a recording period including multiple geographical items;
simulating a segment of continuous track between each two adjacent geographical items;
connecting all segments to complete the continuous track in time sequence;
obtaining multiple media files and creation times thereof, wherein the creation times of the media files are in the recording period of the history file;
adjusting the creation time of one of the media files to match on an actual time base of the history file;
calculating a time difference between the original creation time and the adjusted time;
adjusting the creation times of the reset of the media files to shift to the time difference; and
determining the corresponding geographical coordinate of each media file to the geographical coordinate of the continuous track corresponding to adjusted time of the media file.

2. The method as claimed in claim 1, wherein the geographical coordinate may be a longitude and latitude, or X-axis and Y-axis. The recording time is a Coordinated Universal Time (UTC).

3. The method as claimed in claim 1, wherein the step of simulating a segment of the continuous track further has following acts of:
calculating two control points of the two adjacent geographical items, wherein the speeds of the two adjacent geographical items are respectively multiplied by a parameter K to have two products, and then the two products are further converted to two vectors according to the two headings, wherein the two vectors are transformed to the control points.

4. The method as claimed in claim 3, wherein the Bézier curve equation is a cubic Bézier curve equation:
B(t)=A(1−t)³+3A′t(1−t)²+3Bt²(1−t)+B′t³; tε[0,1], wherein
A and B are adjacent geographical items;
A′ and B′ are control points of the A and B; and
t is a time parameter.

5. The method as claimed in claim 4, wherein the time parameter presents a proportion of an arbitrary time and the two recording times of the two the adjacent geographical items and is calculated by an equation: t=(tx−t0)/(t1−t0), wherein:
t0 and t1 are recording times; and
t1 is the arbitrary time.

6. An information processing system comprising:
a media file generator generating media files each of which has a creation time;
an GPS recorder generating a history file having multiple geographical items each of which has a recording time, a geographical coordinate, speed and heading;
a data processing system connected to the media file generator and the GPS recorder and executes the information processing method as claimed in one of claim 1 to 5.

7. The information processing system as claimed in claim 6, wherein the GPS recorder is embedded inside the media file generator.

8. The information processing system as claimed in claim 6, wherein the media file generator is a digital camera, video recorder or an audio recorder.

9. The information processing system as claimed in claim 6, wherein the media file generator has an internal clock to generate a local time used as the creation time of the media file, wherein each media file supports Exchangeable Image File Format, so the creation times of the media files are respectively recorded within the corresponding media file.

10. The information processing system as claimed in claim 7, wherein the media file generator has an internal clock to generate a local time used as the creation time of the media file, wherein each media file does not support Exchangeable Image File Format, so the creation times of the media files are respectively kept on its file creation time of the file system.

11. The information processing system as claimed in claim 6, wherein when the data processing system executes the step of adjusting the creation time of one media file, the data processing system displays the continuous track and the media files marked on the continuous track on an image of an electric map.

12. The information processing system as claimed in claim 7, wherein when the data processing system executes the step of adjusting the creation time of one media file, the data processing system displays the continuous track and the media files marked on the continuous track on an image of an electric map.

13. The information processing system as claimed in claim 11, wherein the data processing system executes the step of determining the corresponding geographical coordinate of each media file, the data processing system displays the continuous track and the media files marked on the continuous track on an image of an electric map.

14. The information processing system as claimed in claim 12, wherein the data processing system executes the step of determining the corresponding geographical coordinate of each media file, the data processing system displays the continuous track and the media files marked on the continuous track on an image of an electric map.

15. The information processing system as claimed in claim 13, wherein the time difference is calculated after the processing system executes the step of calculating the time difference, and then the time difference is stored in the data processing system, wherein
the data processing system automatically adjusts creation times of a new set of media files downloaded from the same media file generator to shift the time difference.

16. The information processing system as claimed in claim 14, wherein the time difference is calculated after the processing system executes the step of calculating the time difference, and then the time difference is stored in the data processing system, wherein
the data processing system automatically adjusts creation times of a new set of media files downloaded from the same media file generator to shift the time difference.
